(19) United States
(12) Patent Application Publication
(10) Pub. No.: US 2007/0278804 A1
(43) Pub. Date: Dec. 6, 2007

(54) Vehicle door protection systems

(76) Inventor: Frank Shields, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/445,489

(22) Filed: May 31, 2006

(51) Int. Cl. B60R 19/42

(52) U.S. Cl. 293/128

(57) ABSTRACT

In one embodiment, a vehicle door protection system is provided. The system includes a compressible pad having memory, wherein the compressible pad defines a first opening there through, a user-removable tether having a first end looped through the first opening, and an anchor is slidably coupled to the tether so that the tether length between the anchor and the compressible pad is user adjustable.

### BACKGROUND OF THE INVENTION

1. Field of the Invention

The present invention is related to protective systems and methods, and in particular, to systems and methods for protecting vehicle doors.

2. Description of the Related Art

Vehicles doors are constantly subject to dings and dents. The problem of door dings and dents has become an increasingly significant problem in parking lots with the increasing number of wider vehicles, such as sport utility vehicles, and increasingly larger and heavier doors. Several conventional approaches have been taken to protect vehicle doors, however many of them suffer from various deficiencies. For example, certain approaches require a relatively heavy door protection device requiring multiple mounting points. Other approaches require protection bumpers or straps to be permanently mounted by the car manufacturer or a professional installer to the vehicle with complex hardware for extending and retracting the protector. Still other protection devices protect a relatively small area of the door and may be easy to steal when in use. Still other embodiments rely on magnets to hold the protection device against a car door, however, magnets may not work with certain vehicles that have fiberglass or other non-metal doors. In addition, the protection devices of certain conventional embodiments are too thin and do not provide adequate protection to the vehicle door.

### SUMMARY OF THE INVENTION

The present invention is related to protective systems and methods, and in particular, to systems and methods for protecting vehicle doors.

As described herein, certain embodiments provide vehicle door protection using foam or other protective materials. Various embodiments can be mounted using magnets, tethers, and/or otherwise. Certain embodiments include an area for printed indicia. In addition, certain embodiments can optionally be mountable on either a vehicle or a wall.

One example embodiment is a automotive vehicle door protection system having memory, comprising: a compressible pad having memory, wherein the compressible pad defines a first opening there through, and wherein the compressible pad having memory changes it's shape in response to user applied pressure and the changed shape is substantially retained after the user removes the pressure; a user-removable tether having a first end looped through the first opening; and an anchor slidably coupled to the tether so that the tether length between the anchor and the compressible pad is user adjustable, wherein the anchor is configured to be coupled to a portion of the automotive vehicle so that the compressible memory pad is positioned to protect an automotive vehicle door.

Another example embodiment provides a vehicle door protection and tether system, comprising: a compressible pad having memory; a tether coupled to the compressible pad without using a pouch; and an anchor coupled to the tether, wherein the tether length between the anchor and the compressible pad is user adjustable, wherein the anchor is configured to removably anchor the tether to a portion of the vehicle so that the compressible memory pad is positioned to protect a vehicle door.

Another example embodiment provides a vehicle door protection system, comprising: a compressible pad; and a magnet coupled to the compressible pad, and configured to hold the compressible pad to a vehicle door.

Another example embodiment provides a vehicle door protection system, comprising: a pad configured to provide protection to a vehicle door; at least one magnet coupled to the pad; and a sealed disposable plastic bag in which the compressible foam pad and the magnet is placed, wherein the magnet is configured to hold the pad and the sealed plastic bag to a vehicle door.

Another example embodiment provides a vehicle door protection system, comprising: a first hoop; a compressible foam pad coupled to the first hoop; and a first adjustable tether having an anchor, wherein the anchor is configured to be positioned at least partly within the vehicle while the first hoop and compressible foam pad are positioned external to the vehicle, when the vehicle door protection system is being used to protect a door, wherein the first adjustable tether can be adjusted to position the compressible foam to overlay at least a portion of a vehicle door.

Another example embodiment provides a vehicle door protection system, comprising: a foam piece configured to provide vehicle door protection, the foam piece having a rounded side and a substantially flat side, wherein the rounded side has a flattened or recessed indicia bearing portion; and a mounting system, including one or more of a magnet, an adhesive, or double sided tape, wherein the mounting system is configured to removably mount the foam piece to the exterior side of a vehicle door, with the rounded side facing outward.

Another example embodiment provides a vehicle exterior protection system, comprising: a pad intended to protect at least a vehicle door, wherein the pad is foldable about a first fold line, the first fold line between an upper pad portion and a lower pad portion; a first magnet affixed to the upper pad portion; and a second magnet affixed to the lower pad portion, wherein when the pad is folded about the fold line, the first magnet is attracted to the second magnet to hold the pad in a folded position, and when the pad is the open position, at least one of the first and second magnets can be used to removably attach the pad to the vehicle door.

Another example embodiment provides a vehicle door protection, comprising: a pad having an opening; a tether having a looped end and a plurality of distributed stops, wherein at least a portion of the tether can be inserted through the pad opening, and at least one end of the tether can be inserted through the looped end.

### BRIEF DESCRIPTION OF THE DRAWINGS

Example embodiments of a door protection system are illustrated in the accompanying drawings, which are for illustrative purposes only. The drawings comprise the following figures, in which like numerals indicate like parts.

FIG. 1 illustrates a front plan view of a first example embodiment of the door protection system.

FIG. 2 illustrates a front plan view of the first example embodiment of the door protection system removable mounted to a vehicle.

FIG. 3 illustrates a rear plan view of an example protection pad.

FIGS. 4A-B illustrate another example embodiment of a door protection system, including a disposable bag providing pad protection.

FIGS. 5A-B illustrate an example embodiment of a door protection system illustrating example magnet placement.

FIG. 6 illustrates yet another example embodiment of a door protection system.

FIGS. 7A-B illustrate still another example embodiment of a door protection system.

FIG. 8 illustrates another example embodiment of a door protection system.

FIGS. 9A-B illustrate another example embodiment of a door protection system.

### DETAILED DESCRIPTION OF PREFERRED EMBODIMENTS

The present invention is related to protective systems and methods, and in particular, to systems and methods for protecting vehicle doors. However, certain embodiments can be used for applications other than vehicle doors.

In an example embodiment, a door protection system includes a pad comprising of foam. The pad is bendable to conform to the curvature of a vehicle door. Optionally the pad has memory. By way of example, the foam is optionally flexible polyurethane foam having memory without the need for separate stiffeners, such as metal rods. The foam can be open cell or closed cell foam, by way example. The foam is advantageously light and is mildew and/or water resistant. In addition, the foam can optionally be molded, and can be easily cut into the desired shape and size. Thus, for example, a user can purchase the door protection system, and then cut the door protection system pad to the desired size or shape. In other embodiments, the pad can be latex or other rubber, plastic, fabric, metal, or other material. In addition, optionally the user can cut recessed areas or holes in the foam to allow a door handle to protrude, to provide access to a door lock, or for other reasons.

In one embodiment, the pad includes a tether which is mountable between a top edge of a door frame and the vehicle frame. Optionally, the tether is mountable between the top edge of a door window and the door frame. If the door window is frameless, the tether can be mounted between the top edge of the window and the vehicle frame that surrounds the vehicle window when the door is closed. By way of example, the tether can be mounted to a car or other vehicle using an anchor mounting device, such as a knot, button, buckle, hook, or the like. By way of further example, the mounting device (e.g., hook, buckle, etc.) can include thread slots in which one end of the tether be threaded to thereby adjust the length of the tether between the mounting device and the pad. This enables a user to adjust the tether length so that the protection pad rests at the appropriate or desired location against the door. Similarly, if a knot is used, the user can selectively tie a knot in the tether so as to appropriately adjust the length of the tether between the mounting device and the pad.

The tether can be mounted to the pad by threading or looping the tether through one or more slots in the pad, by threading the tether through a hole in the pad and knotting the tether, via snaps (e.g., having one of a snap pair mounted on the tether, and the snap mate mounted on the pad or on another portion of the tether), using Velcro or other hook and loop implementation, by permanently mounting the tether to the pad by molding the pad around an end of the tether, by riveting the tether to the pad, or otherwise. The tether can be a fabric (e.g., seatbelt fabric, or other fabric), a cord (e.g., a rope cord, a rubber cord, a steel or other metal cord sheathed in rubber or plastic, etc.), a chain (e.g., a plastic chain, or metal chain sheathed in a material, etc.), etc.

Optionally, instead of or in addition to the tether, magnets and/or suction cups can be used to hold the pad against the vehicle door. Advantageously, in an embodiment with both magnets and a tether, the tether can optionally bear the weight of the pad, and so the magnets, which hold the pad against the door, can optionally be relatively smaller and/or of lower gauss rating then if there were no tether and the magnets had to support the full weight of the pad.

Optionally, more than one tether can be used. For example, tethers may be used that hook onto or are otherwise coupled to a wheel well, the bottom edge of a car (or other vehicle) door, the side edge of a car door, a roof rack, and/or the like. The tethers can be mounted at various pad locations as appropriate (e.g., toward the top edge, the bottom edge, the left edge, and/or the right edge). Further, the pad can be sized as to protect a front door and a rear door, wherein two tethers can be provided, one to suspend the pad from the front door window and one to suspend the pad from the rear door window.

In addition, the protection system can optionally be configured to be mountable on a vehicle, as described above, and on a wall, such as a garage wall, to protect a car door from striking the wall. Thus, for example, in addition to a vehicle mounting system, the pad may include a wall mounting system. For example, the pad may include one or more precut or predrilled holes through which a nail or screw can be inserted to hold or affix the pad against a wall. The holes can optionally be protected by a grommet. In an example embodiment, the pad can be affixed to a wall using a loop and hook arrangement, wherein one of the loop and hook pair is mounted to the back of the pad using glue, double sided tape, or thread, and the other half of the pair is mounted to the wall using glue or double sided tape. More than one hook and loop pair can be used. Optionally, double sided tape can be applied to one side of the pad, which can then be pressed against the wall.

Optionally, a portion of the pad includes a planar, raised, or depressed indicia area, wherein indicia can be printed or embossed thereon. For example, a user can have the user's vehicle license plate number or name imprinted thereon, which can further discourage the theft of the protection system.

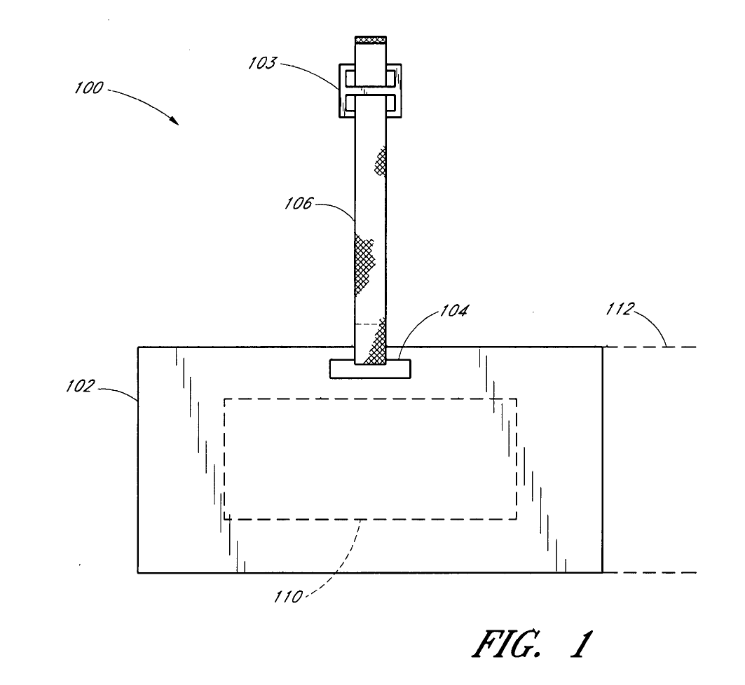

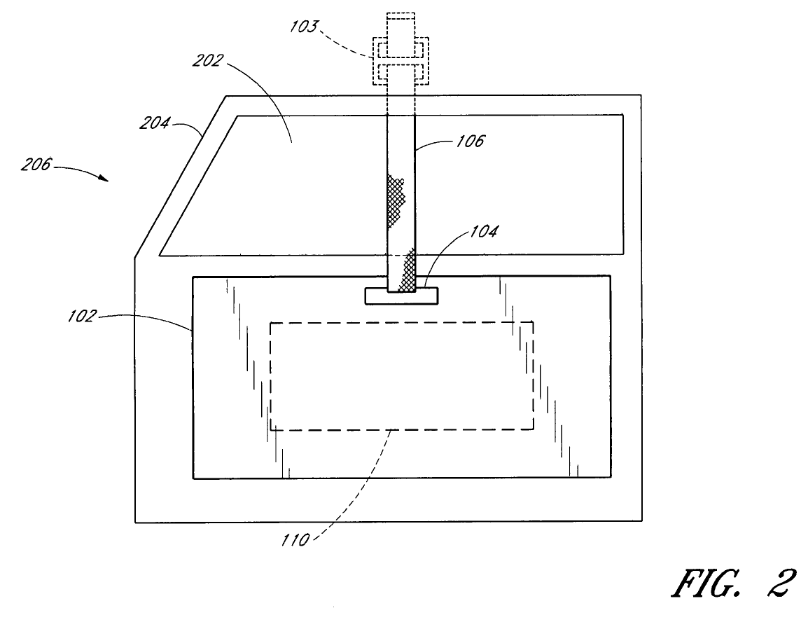

With reference now to the figures, FIG. 1 illustrates an example embodiment of a protection system 100. This embodiment includes a pad 102. In this example, the pad is not enclosed in a separable pouch system and does not have folding points. Other optional embodiments can include one or more pouches and can include folding points or creases. As discussed above, the pad 102 can be manufactured from a variety of materials, such as foam, rubber, plastic, metal, fabric, and/or other materials. Optionally, the pad 102 can be a unitary piece of compressible, cell-based foam. Optionally, the pad 102 can have shape memory so that once the pad 102 is curved or bent to conform to a vehicle door, the pad 102 will substantially retain the curved or bent shape until pressure is applied to reshape the curve of the pad 102 or until a significant amount of time has passed (e.g., day, weeks, months, etc). The memory can be provided via the padding material (e.g., the foam), and/or the memory can be provided via a stiffening structure, such as metal rods or an articulated frame located within or otherwise affixed to the pad 102.

The pad 102 can be a variety of sizes. For example, the pad 102 can be 2 feet long, 3 feet long, 4 feet long, or other lengths. By way of further example, the pad 102 can be can be 6 inches high, 1 foot high, 1.5 feet high, 2 feet high, 2.5 feet high, 3 feet high, or other height. By way of further example, the pad length to height ratio can in the range of 2:1 to 4:1, although other ratios can be used as well. The pad thickness can be 0.25 inches, 0.5 inches, 0.75 inches, 1 inch, 1.5 inches, 2 inches, 2.5 inches or other desired thickness. Where the pad includes foam, the foam density rating, by way of example, can be 1, 1.5, 2, 3, 4, 5, 6, 7, 8, 9, 10 pounds per cubic foot, although foams having higher or lower density ratings can be used as well. The foam compression rating (in pounds per squire inch) can be in the range of 5-9, although foams having higher or lower compression ratings can be used as well. The foam can have a hardness rating of about 30, 35, 40, 45, 50, 55, or 60 Durometer Shore, although the although foams having higher or lower hardness ratings can be used as well. The compression set can be less than 50%, less than 40%, less than 35%, less than 30%, less than 20% or other percentage. The tensile strength can be in the range of 50-100 psi, 100-150 psi, less than 50 psi, or more than 150 psi. The tear strength can be in the range of about 1-10 lb/in, or greater than 10 lb/in. The foam elongation % can be about 110%, 120%, 125%, 130%, greater than 130%, or between 100%-110%. The foam resilience can be less than 20%, about 20%, 25%, 30%, 35%, 40%, or more than 40%. The water absorption of the foam, measured as a weight change percentage, can be less than 5%, less than 10%, less than 20%, or other percentage. Optionally, the pad can be formed from a fire retardant material, such as fire retardant foam.

In this example, an opening 104 is provided (e.g., via molding or by cutting the opening) via which a first end of a tether 106 is inserted and looped around to attach to another portion of the tether 106. For example, a hook and loop arrangement or a snap arrangement (not shown) can be used to removably attach the first end of the tether to another portion of the tether 106. Optionally, the tether end is fixedly attached to another portion of the tether 106 using rivets, or by being sewn together, thereby making it more difficult for someone to remove the pad 102 from the tether 106 and steal the pad 102. Optionally, more than one tether can be used. Additional tethers can be mounted to the pad 102 using the same or different techniques as discussed above with respect to tether 106. Optionally, the opening 104 can be sized as a carrying handle so that a user may carry the pad 102.

In this example, a threaded buckle 108 has a second end of the tether 106 threaded there-through. The buckle 108 can then be inserted between the door window and window frame as discussed elsewhere herein. The tether 106 is optionally relatively narrow (e.g., 0.5, 1, 2, 3, or 4 inches wide) so as to be more manageable and to avoid obscuring most of the vehicle window. In other embodiments, the tether can be wider.

Optionally, the pad 102 can be sized as to protect a front and a rear door, and can have two tethers, the tether 106 to suspend the pad from the front door window, and another tether (not shown) used to suspend the pad 102 from the rear door window. Optionally instead, a single tether 106 can be used to suspend the pad 102 from a first door window, such as the front door window, and a portion 112 of the pad 102 can be long enough to protect a second door as well. In an example embodiment, the tether 106 (and opening 104 if one is used) is optionally mounted off-center with respect to the pad 102, and optionally pad magnets that are attracted to the car's metal door(s) are used to help balance the pad 102.

The pad 102 optionally further includes an indicia area 110, whereupon user specific information (e.g., a license plate number, a user name, a car name, etc.) can be printed or impressed on. Optionally, the indicia area 110 is physically configured so such indicia printing will be substantially permanent. For example, the indicia 110 area can be chemically treated or have an appropriate coating or covering so as to provide good adhesion for ink, such as marker ink, ink jet printer ink, UV curable inks, flexographic water base inks, silk screened inks, etc.

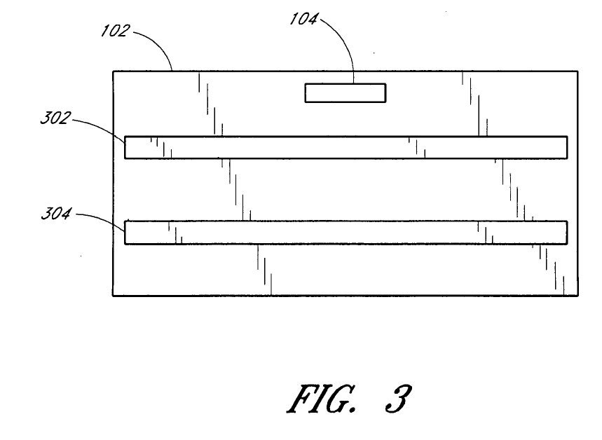

FIG. 2 illustrates the protection system 100 illustrated in FIG. 1, removably mounted to a car. The buckle 108 is placed between the car window 202 and the window frame 204. In this example, the pad 102 is curved to conform to the car door 206, although optionally the pad can remain flat or otherwise in its original shape.

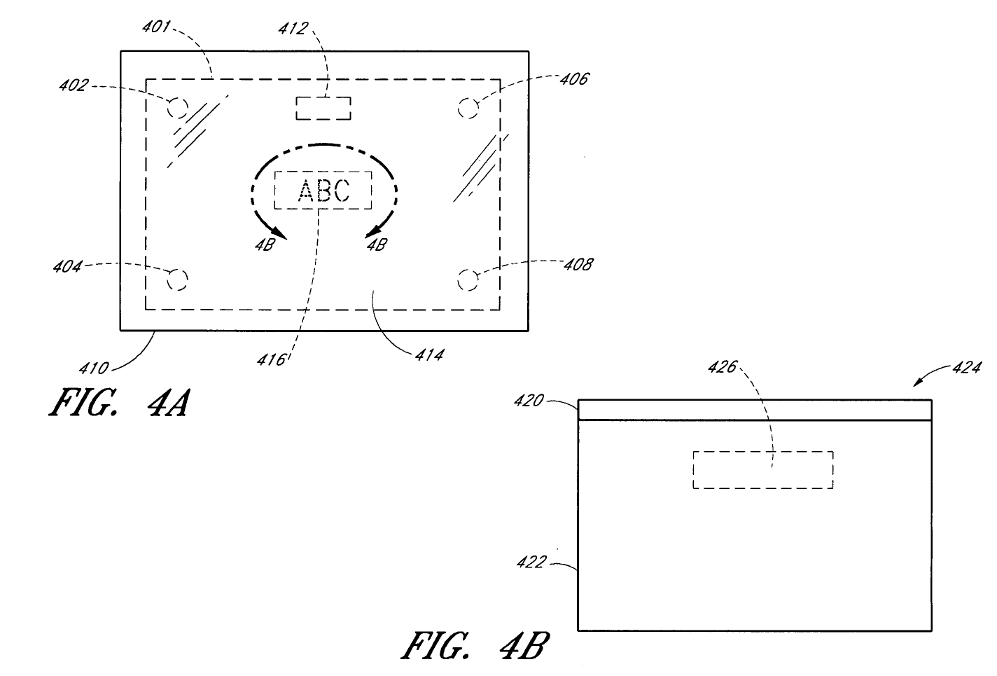

FIG. 3 illustrates another example embodiment with magnetic strips 302, 304 bonded or glued to the rear of the pad 102. Optionally, the magnetic strips 302, 304 can be configured to be cut with scissors or a knife so that a user can size the pad 102 as desired. For example, the magnetic strips 302, 304 can be magnetic impregnated rubber, magnetic vinyl, or other magnetic cutable material. The magnetic strips 302, 304 can be oriented vertically, horizontally, or diagonally. One or more magnetic pieces can be used. Rather than using relatively narrower strips, a flexible, optionally cutable, thin magnetic panel that has between half and the same length and height of the pad 102, can be glued or otherwise affixed to the backside of the pad 102.

In the example illustrated in FIG. 3, a tether mounting opening 104 is optionally provided via which a tether can be user affixed. In addition, the opening 104 can optionally be used as a carrying handle. Other tether mounts can be used, such as snaps, etc.

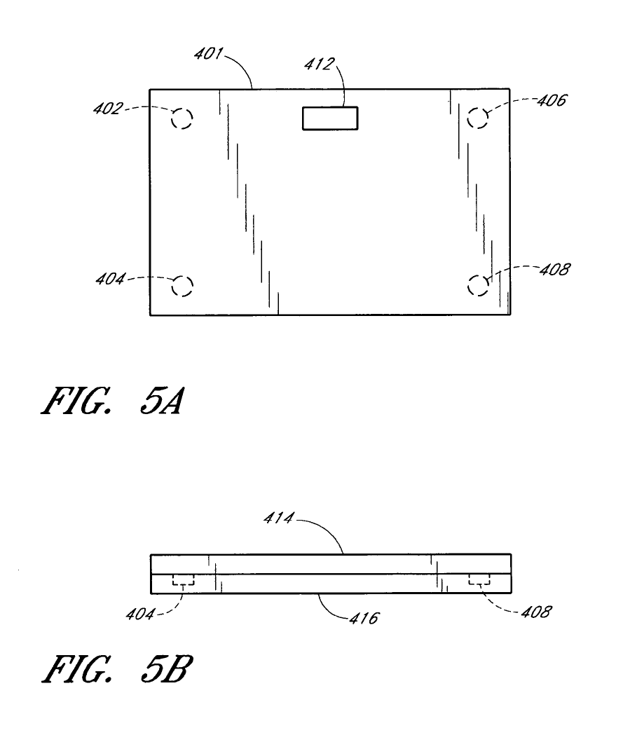

With reference to FIGS. 4A-B, in another example embodiment, a pad 401, such as an embodiment of a pad as described herein, can be configured for different forms of use. For example, the pad 401 can be placed in a plastic (e.g., polyethylene or low density polyethylene (LDPE)) bag or wrapper 410. The plastic bag or wrapper 410 can be a low-cost, disposable bag or wrapper (herein after, collectively referred to as a bag), which can, in one embodiment be “permanently” sealed (e.g., heat sealed, glued shut, etc.), wherein in order to remove the pad, the bag is ripped or cut open. In another embodiment, the disposable bag 410 can have a seal that can be opened without damaging the bag (e.g., a zipper seal, or a flap closure with adhesive that can be opened and closed multiple times with rendering the adhesive nonfunctional).

The low cost plastic wrapper can include an area 416, with indicia text, such as an advertisement or an automobile manufacturer name, logo, and/or model name, printed thereon. Such a plastic bagged pad can be used when the automobile is being shipped to protect the automobile during shipment (e.g., when being shipped from the manufacturer to the destination), wherein the disposable bag 410 protects the pad from dirt and/or moisture during shipping.

The pad 401 in this embodiment can include magnets 402, 404, 406, 408 (e.g., a magnet in the area of each pad corner) to hold the pad 401 against the automobile while the pad is enclosed in the plastic bag 410. Thus, the pad 401, while in the disposable bag 410, can be placed against an automobile door, and the magnetic field generated by the magnets 402, 404, 406, 408 holds the bagged pad 401 against the door.

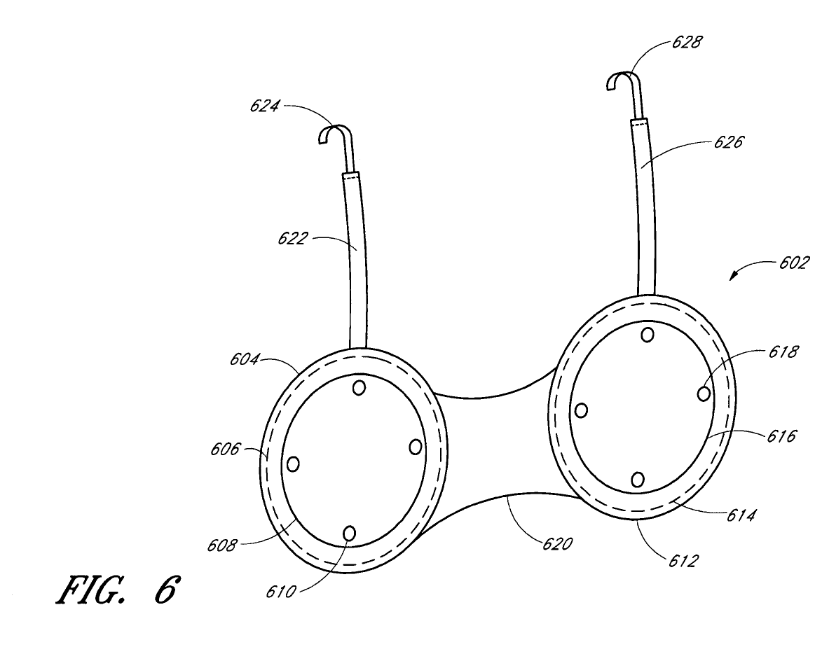

With reference to FIGS. 5A-B, by way of example and not limitation, the pad 401 can include two pieces of foam 414, 416 joined together (e.g., via an adhesive or heat), with magnets inserted in slots or receiving areas 404, 408 formed on an inner side of at least one of the two pieces, wherein the magnets are closer to one outer surface 416 of the complete pad than the opposite outer surface 414.

Referring to FIG. 4B, once the automobile has arrived at the destination (e.g., an automobile dealer), the pad can be removed from the low cost plastic bag (which can optionally be disposed of), and placed in a higher grade bag or pouch, such as a leather, or high grade vinyl pouch 424, and provided to an automobile purchaser as a promotional item or as a purchased option item. The pouch 424 can include a pocket area 422 used to receive the pad 401, and a flap 420 used to seal the pouch 424. The exterior of the pocket area 422 and the flap 420 can having matting fasteners (e.g., hook and loop fastener, snaps, or button and button holes). The higher grade pouch 424 can have an area 426 wherein the automobile manufacturer name, logo, automobile dealer name, model name, customer name, and/or license plate number is optionally printed thereon. The higher grade pouch 424 can be used for storage of the pad 401 and/or used to protect or hold the pad 401 while in use. The pad 401 can be held against the automobile while in the higher grade pouch 424 or after being removed from the higher grade pouch 424 using one or more of the mechanisms described above with respect to FIGS. 1-3 (e.g., magnets, a tether, a tether having an adjustable length, magnets and a tether, etc.). Optionally, a bag with a drawstring to cinch the bag can be sized and provided to hold the pad 401.

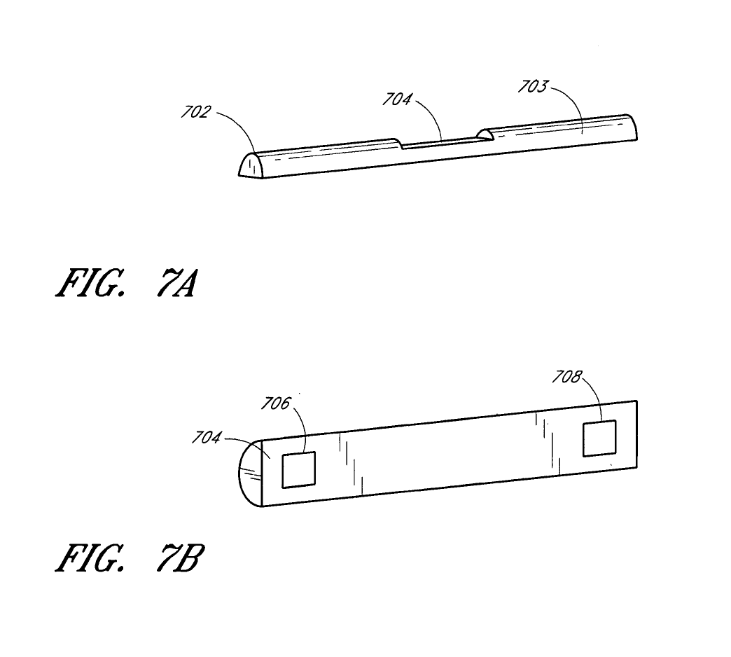

With reference to FIG. 6, in another embodiment, the foam material 606, 616 (e.g., in the form of circular, oval, square or rectangular panels) can be coupled to fabric 604, 612 attached to one or more deformable hoops 606, 614. The hoops 606, 614 can be circular or oval in shape, or of another shape. By way of example a hoop system can include two spring wire or plastic hoops, each inserted within a sleeve, or otherwise attached to a circular, oval or rectangular flexible base material panel (e.g., canvas, polyester, etc.). The sleeves can be formed by folding over the perimeter of the flexible base fabric and sewing or gluing the edge of the folded over portion to a portion of the base fabric on which the edge is lying. The hoops 606, 614 can provide structure and support for the fabric and foam panels 606, 616 described below.

Foam panels, such as pads, can be mounted to the base material panel (e.g. via snaps 610, 618, glue, by being sewn on, etc.). If two hoops are used, between the two hoops the panel is joined by a hinged section, such as the hinged section 620 illustrated in FIG. 6, which can be a flexible cloth, and the hoop system may be folded thereabout.

Optionally, each hoop segment can include a tether, such as tethers 622, 626. Optionally, the tethers can be mounted to a car or other vehicle using corresponding anchor mounting devices 624, 628, which can be in the form of a knot, button, buckle, hook, or the like as similarly discussed above with reference to FIGS. 1-3. By way of further example, the mounting device (e.g., hook, buckle, etc.) can include thread slots in which one end of the tether be threaded to thereby adjust the length of the tether between the mounting device and the pad. This enables a user to adjust the tether length so that the hoop system rests at the appropriate or desired location against the door.

The hoop system can serve a dual purpose, wherein the hoop system can be used internal to the automobile, against the front or rear window, to block the sun as a sun shield, or used external to the automobile, as a door shield. The hoop system can optionally be compressible and foldable. For example the hoop system can be compressed and folded for storage. A snap, hook and loop fastener, belt, or other device is optionally used to hold the hoop system in the folded state. When in the folded state, the hoop system can be stored in a matching storage pouch, similar to that described above with respect to FIG. 4. When two or more hoops are used, the hoop system can be folded in half, or smaller, for used as a door shield on a relatively small automobile (e.g., a sedan or coupe), or used in the unfolded state for use on a relatively larger automobile (e.g., a truck or van). The hoop system can be held against the outer body of the automobile using one or more of the mechanisms described above (e.g., magnets, a tether, magnets and a tether, etc.).

Optionally, a given pad can be removed from the hoop system and used as a door protection device without the remainder of the hoop system.

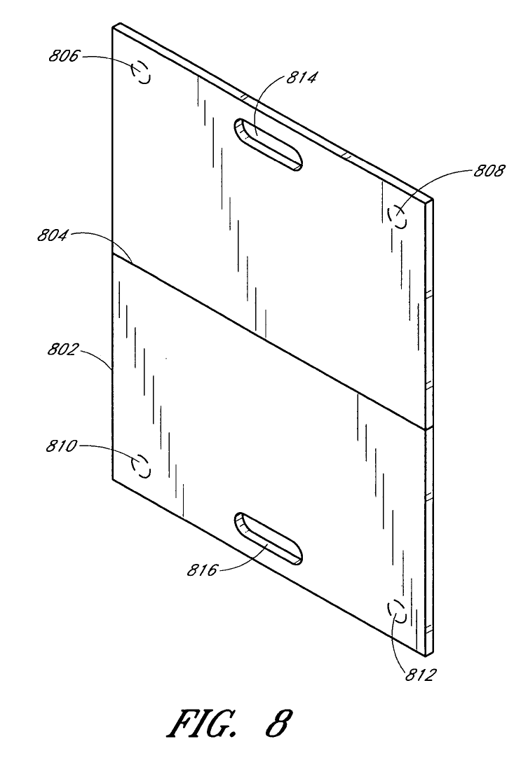

Referring to FIG. 7, in another example embodiment, the protective device 702 can be in the form of foam polystyrene, or a like material. In this embodiment, the foam polystyrene protective device 702 can be held against the outer body of the automobile using one or more of the mechanisms described above (e.g., magnets, a tether, magnets and a tether, etc.), via adhesive, double-sided tape, or otherwise, as illustrated by the example attachments devices 706, 708. The polystyrene protective device 702 is optionally in the form of a half solid cylinder, having a relatively flat side 704 and a rounded side 703. Optionally, the rounded side 703 has a flattened and/or recessed portion 704 on which the automobile manufacturer name, logo, automobile dealer name, and/or model name is printed thereon. The flat side can have two sided tape, adhesive, and/or magnets positioned thereon to mount the device 702 to an automobile, with the rounded side 703 (any text printed thereon), facing out.

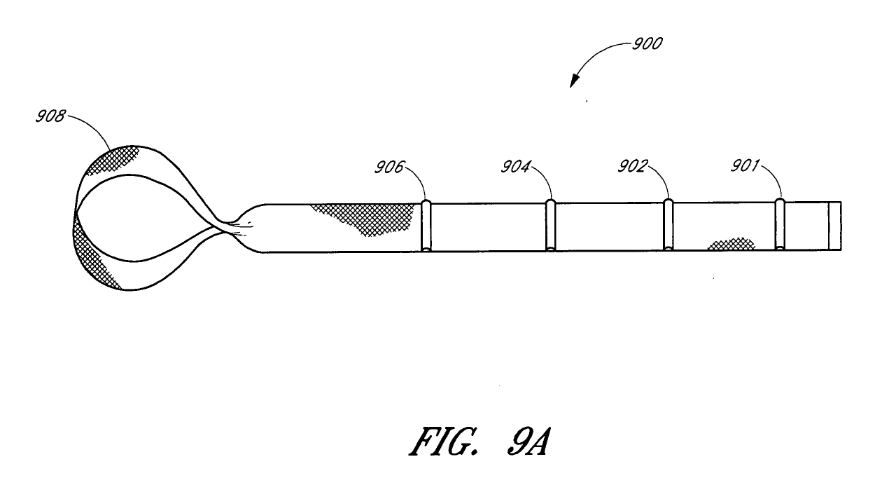

FIG. 8 illustrates another example embodiment. A protective device 802 is foldable about a line 804 so that the device 802 can be folded in half. The line can be a straight line, a curved line, or other type of line. The line can have a width that varies. The line can extend the full or partial width or length of the device. In an illustrative example, the device portion above the line can be foldably jointed to the portion below the line by a flexible material or a hinge. The flexible material can be formed from the same material as used in the upper and lower device portions, or can comprise a different material.

The portion of the device 802 above the line can be rectangular (as illustrated), a triangle, a semi-circle, or other shape. The shape portion of the device 802 below the line can optionally mirror that of the top portion. The device 802 can be made out of a variety of materials, including those disclosed herein, such as open cell foam, closed cell foam, latex or other rubber, plastic, fabric, metal, or other material.

The device 802 includes magnets 806, 808, 810, 812 that can be used to hold the device 802 against the exterior side of the vehicle door or other appropriate body part. Optionally, the polarity of the magnets 806, 808 are the opposite of the polarity of the magnets 810, 812 with respect to the front side 818 of the device 802. Thus, when the device 802 is folded, the magnets 806, 808, will be attracted to the magnets 810, 812, and will thereby hold the device 802 in the folded position. The user can then unfold the device 802 using sufficient force to overcome the magnetic attraction.

As similarly discussed above with respect to FIGS. 5A-B, the device can include two pieces of foam (e.g., via an adhesive or heat), with magnets inserted in slots or receiving areas formed on an inner side of at least one of the two pieces. Other magnet configurations can be used as well. For example, each side can have one or more strip magnets.

Holding handles 814, 816 are optionally provided, wherein when the device 802 is folded, the handles match up to form one carrying handle. When in the folded state, the device 802 can be stored in a matching storage pouch, similar to that described above with respect to FIG. 4. The pouch is optionally sized to closely match the dimensions of the folded device (e.g., so that the folded device fits into and fills the pouch, without leaving significant portions of the pouch loose and without support) without and can be sealable using a hook and loop arrangement, a zipper, a snap, a button, or otherwise. One or more tethers can also be provided, as similarly described above. Optionally, an area can provided on which indicia, such as a license plate number, can be printed, as similarly described above. The device dimensions can optionally be the same as those discussed above with reference to FIG. 1.

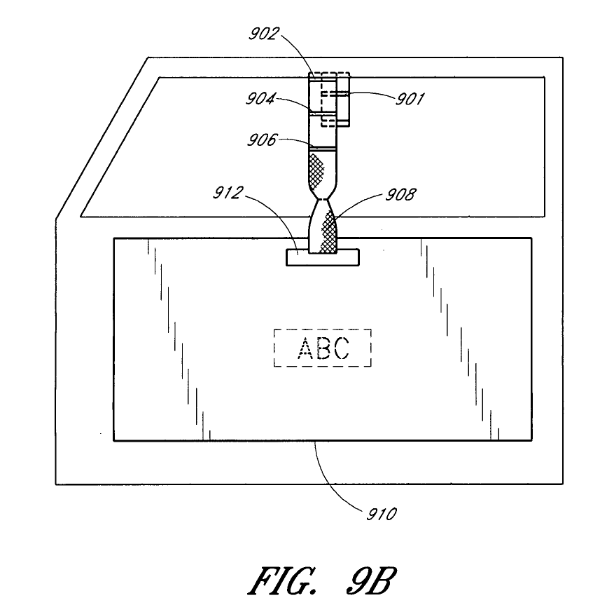

FIGS. 9A-B illustrate another example embodiment of a door protection system. FIG. 9A illustrates a tether 900. The tether can be made from a variety of materials, including, but not limited to, seat belt webbing material, plastic, rubber, cloth, and/or leather. The tether includes a plurality of stops, 901, 902, 904, 906. A stop may be formed by folding over a portion of the tether material once or twice, and sewing the folded over portion to form a flap. The flap thickness will depend on how many times the tether material was folded over to form the flap. For example, if the material was folded or gathered once, the flap will be twice as thick as the unfolded portion of the tether. Optionally, the stop can instead or in addition be formed using rivets (e.g., plastic or metal rivets) inserted through the tether material.

At a first end of the tether 900 a loop 908 is provided. With reference to FIG. 9B, the loop can be inserted through an opening 912 in a pad 910, and the opposite end of the tether 900 can be inserted through the loop and pulled tight to hold the pad 910.

A stop can be used to anchor the tether 900 to a vehicle by inserting a portion of the tether with a stop between a vehicle window and door frame or roof, and the stop will prevent the tether 900 from slipping out of the vehicle once the window is closed. A user can adjust the length of the tether 900 hanging outside the vehicle by selecting an appropriate stop. For example, if a user desires the pad 910 to be posited relatively lower, stop 901 may be used. If the user desires the pad 910 to be positioned relatively higher, stop 906 may be used. Optionally, the pad can have one or more other openings via which a nail, screw, bolt or other fastener can be inserted to fasten the pad 910 to a wall to protect the wall and a vehicle door from coming into direct contact when the door is opened. Optionally, the openings can be circular with a plastic, metal, or rubber grommet to protect the pad material. The pad 910 can be configured as similarly described above with respect to other embodiments.

Thus, as described herein, certain embodiments provide vehicle door protection using foam or other protective materials. Various embodiments can be mounted using magnets, tethers, or otherwise. Certain embodiments include an area for printed indicia. In addition, certain embodiments can optionally be mountable on either a vehicle or a wall.

It should be understood that certain variations and modifications of this invention would suggest themselves to one of ordinary skill in the art. The scope of the present invention is not to be limited by the illustrations or the foregoing descriptions thereof.

What is claimed is:

1. An automotive vehicle door protection system having memory, comprising:
a compressible pad having memory, wherein the compressible pad defines a first opening there through, and wherein the compressible pad having memory changes it's shape in response to user applied pressure and the changed shape is substantially retained after the user removes the pressure;
a user-removable tether having a first end looped through the first opening; and
an anchor slidably coupled to the tether so that the tether length between the anchor and the compressible pad is user adjustable, wherein the anchor is configured to be coupled to a portion of the automotive vehicle so that the compressible memory pad is positioned to protect an automotive vehicle door.

2. The automotive vehicle door protection system as defined in claim 1, wherein the automotive vehicle door protection system compressible pad comprises flexible polyurethane memory foam.

3. The automotive vehicle door protection system as defined in claim 1, wherein the automotive vehicle door protection system compressible pad comprises latex.

4. The automotive vehicle door protection system as defined in claim 1, wherein the anchor is slotted to slidably receive the tether.

5. The automotive vehicle door protection system as defined in claim 1, wherein the compressible pad includes an area configured to bear user-defined indicia.

6. The automotive vehicle door protection system as defined in claim 1, wherein the automotive vehicle door protection system compressible pad is at least one inch thick.

7. The automotive vehicle door protection system as defined in claim 1, wherein the automotive vehicle door protection system compressible pad is a unitary structure.

8. The automotive vehicle door protection system as defined in claim 1, wherein the compressible pad is user cutable.

9. The automotive vehicle door protection system as defined in claim 1, wherein the automotive vehicle door protection system compressible pad has a foam density rating of at least 4 pounds per cubic foot.

10. The automotive vehicle door protection system as defined in claim 1, wherein the automotive vehicle door protection system compressible pad has a foam compression set rating in the range of 25-50%.

11. A vehicle door protection and tether system, comprising:
a compressible pad having memory;
a tether coupled to the compressible pad without using a pouch; and
an anchor coupled to the tether, wherein the tether length between the anchor and the compressible pad is user adjustable, wherein the anchor is configured to removably anchor the tether to a portion of the vehicle so that the compressible memory pad is positioned to protect a vehicle door.

12. The vehicle door protection system as defined in claim 11, wherein the vehicle door protection system compressible pad comprises viscolastic memory foam.

13. The vehicle door protection system as defined in claim 11, wherein the vehicle door protection system compressible pad comprises substantially non-water absorbent closed cell foam.

14. The vehicle door protection system as defined in claim 11, wherein the anchor is slotted to slidably receive the tether.

15. The vehicle door protection system as defined in claim 11, wherein the compressible pad includes an area configured to receive marker ink so that the marker ink will adhere.

16. The vehicle door protection system as defined in claim 11, wherein the vehicle door protection system compressible pad is at least one inch thick.

17. The vehicle door protection system as defined in claim 11, wherein the vehicle door protection system compressible pad is a unitary structure.

18. The vehicle door protection system as defined in claim 11, wherein the vehicle door protection system compressible pad has a foam density rating of at least 4 pounds per cubic foot.

19. The vehicle door protection system as defined in claim 11, wherein the vehicle door protection system compressible pad has a foam compression set rating in the range of 25-50%.

20. A vehicle door protection system, comprising:
a compressible pad; and
a magnet coupled to the compressible pad, and configured to hold the compressible pad to a vehicle door.

21. The vehicle door protection system as defined in claim 20, wherein the vehicle door protection system compressible pad comprises memory foam, wherein the compressible pad changes its shape in response to user applied pressure when the pad is placed against a vehicle door and the changed shape is substantially retained after the user removes the pressure.

22. The vehicle door protection system as defined in claim 20, wherein the vehicle door protection system compressible pad comprises substantially non-water absorbent closed cell foam.

23. The vehicle door protection system as defined in claim 20, further comprising a tether coupled to the pad.

24. The vehicle door protection system as defined in claim 20, wherein the compressible pad includes an area configured to accept marker ink.

25. The vehicle door protection system as defined in claim 20, wherein the vehicle door protection system compressible pad is at least one inch thick.

26. The vehicle door protection system as defined in claim 20, wherein the vehicle door protection system compressible pad is a unitary structure.

27. The vehicle door protection system as defined in claim 20, wherein the vehicle door protection system compressible pad has a foam density rating of at least 4 pounds per cubic foot.

28. The vehicle door protection system as defined in claim 20, wherein the vehicle door protection system compressible pad has a foam compression set rating in the range of 25-50%.

29. The vehicle door protection system as defined in claim 20, wherein the compressible pad is configured to be cut to desired dimensions by an end user.

30. A vehicle door protection system, comprising:
a pad configured to provide protection to a vehicle door;
at least one magnet coupled to the pad; and
a sealed disposable plastic bag in which the compressible foam pad and the magnet is placed, wherein the magnet is configured to hold the pad and the sealed plastic bag to a vehicle door.

31. The vehicle door protection system as defined in claim 30, wherein the pad further comprising:
a first pad; and
a second pad coupled to the first pad, wherein the second pad includes at least a first recessed region in which the magnet is positioned.

32. The vehicle door protection system as defined in claim 30, wherein the sealed disposable bag is permanently sealed, so that the sealed disposable bag would be damaged if the pad were removed.

33. The vehicle door protection system as defined in claim 32, further comprising a relatively higher grade bag in which the pad is to be placed after the pad is removed from the disposable bag.

34. The vehicle door protection system as defined in claim 32, further comprising a relatively higher grade bag in which the pad is to be placed after the pad is removed from the disposable bag, the relatively higher grade bag having at least one of the following printed thereon: automobile manufacturer name, logo, automobile dealer name, model name, customer name, or license plate number.

35. The vehicle door protection system as defined in claim 32, further comprising a leather bag or a vinyl bag in which the pad is to be placed after the pad is removed from the disposable bag.

36. The vehicle door protection system as defined in claim 30, wherein the pad is a compressible foam pad.

37. The vehicle door protection system as defined in claim 30, wherein the disposable bag is a polyethylene bag.

38. The vehicle door protection system as defined in claim 30, wherein the disposable bag has indicia related to the vehicle printed thereon.

39. A vehicle door protection system, comprising:
a first hoop;
a compressible foam pad coupled to the first hoop; and
a first adjustable tether having an anchor, wherein the anchor is configured to be positioned at least partly within the vehicle while the first hoop and compressible foam pad are positioned external to the vehicle, when the vehicle door protection system is being used to protect a door,
wherein the first adjustable tether can be adjusted to position the compressible foam to overlay at least a portion of a vehicle door.

40. The vehicle door protection system as defined in claim 39, further comprising a flexible base material having a sleeve portion in which the first hoop is positioned, wherein the compressible foam pad is attached to the flexible base material.

41. The vehicle door protection system as defined in 40, wherein the compressible foam pad is removably attached to the flexible base material.

42. The vehicle door protection system as defined in 40, wherein the first hoop is comprised of spring wire so that the hoop and compressible foam pad can be folded.

43. The vehicle door protection system as defined in 40, further comprising at least a first magnet coupled to the compressible foam pad.

44. The vehicle door protection system as defined in 40, further comprising:
a second hoop;
a second compressible foam pad coupled to the second hoop;
a second adjustable tether having an anchor,
wherein the first adjustable tether can be adjusted to position the second compressible foam to overlay a vehicle door; and
a hinge portion coupling the first hoop and the second hoop so that the vehicle door protection system can be folded.

45. A vehicle door protection system, comprising:
a foam piece configured to provide vehicle door protection, the foam piece having a rounded side and a substantially flat side, wherein the rounded side has a flattened or recessed indicia bearing portion; and
a mounting system, including one or more of a magnet, an adhesive, or double sided tape, wherein the mounting system is configured to removably mount the foam piece to the exterior side of a vehicle door, with the rounded side facing outward.

46. The vehicle door protection system as defined in claim 45, wherein the foam is polystyrene foam.

47. A vehicle exterior protection system, comprising:
a pad intended to protect at least a vehicle door, wherein the pad is foldable about a first fold line, the first fold line between an upper pad portion and a lower pad portion;
a first magnet affixed to the upper pad portion; and
a second magnet affixed to the lower pad portion,
wherein when the pad is folded about the fold line, the first magnet is attracted to the second magnet to hold the pad in a folded position, and when the pad is the open position, at least one of the first and second magnets can be used to removably attach the pad to the vehicle door.

48. The vehicle exterior protection system as defined in claim 47, wherein the pad comprises flexible polyurethane memory foam.

49. The vehicle exterior protection system as defined in claim 47, wherein the pad comprises a polyurethane foam.

50. The vehicle exterior protection system as defined in claim 47, wherein the pad comprises latex.

51. The vehicle exterior protection system as defined in claim 47, wherein the pad is at least one inch thick.

52. The vehicle exterior protection system as defined in claim 47, wherein the pad has a foam density rating of at least 4 pounds per cubic foot.

53. The vehicle exterior protection system as defined in claim 47, wherein the pad has a foam compression set rating in the range of 25-50%.

54. The vehicle exterior protection system as defined in claim 47, further comprising a tether configured to enable the pad to be suspended from an anchor.

55. The vehicle exterior protection system as defined in claim 47, further comprising a tether coupled to the pad and configured to enable the pad to be suspended from an anchor, wherein the tether length between the pad and the anchor is adjustable.

56. The vehicle exterior protection system as defined in claim 47, wherein the pad includes an area configured to bear user-defined indicia.

57. The vehicle exterior protection system as defined in claim 47, further comprising a reusable container sized to hold the pad while folded.

58. The vehicle exterior protection system as defined in claim 47, wherein the upper portion and the lower portion are foldably coupled via a flexible material.

59. The vehicle exterior protection system as defined in claim 47, wherein the upper portion and the lower portion are foldably coupled via a hinge.

60. The vehicle exterior protection system as defined in claim 47, wherein the upper portion had a first cutout and the lower portion has a second cutout, wherein when the pad is folded, the first cutout overlays the second cutout.

61. The vehicle exterior protection system as defined in claim 47, wherein the fold line is straight at least in part.

62. The vehicle exterior protection system as defined in claim 47, wherein the fold line is curved at least in part.

63. A vehicle door protection, comprising:
a pad having an opening;
a tether having a looped end and a plurality of distributed stops, wherein at least a portion of the tether can be inserted through the pad opening, and at least one end of the tether can be inserted through the looped end.

64. The vehicle door protection system as defined in claim 63, wherein the pad is compressible.

65. The vehicle door protection system as defined in claim 63, wherein the pad comprises viscolastic memory foam.

66. The vehicle door protection system as defined in claim 63, wherein the tether comprises seat belt webbing.

67. The vehicle door protection system as defined in claim 63, wherein at least one stop is formed by folding over a portion of tether material.

68. The vehicle door protection system as defined in claim 63, wherein at least one stop is formed by inserting a rivet through tether material.

69. The vehicle door protection system as defined in claim 63, wherein the pad comprises substantially non-water absorbent closed cell foam.

70. The vehicle door protection system as defined in claim 63, wherein the pad is at least one inch thick.

71. The vehicle door protection system as defined in claim 63, wherein the pad is a unitary structure.

72. The vehicle door protection system as defined in claim 63, wherein the pad has a foam density rating of at least 4 pounds per cubic foot.

73. The vehicle door protection system as defined in claim 63, wherein the pad has a foam compression set rating in the range of 25-50%.

74. The vehicle door protection system as defined in claim 63, wherein the pad has a water absorption, as measured by weight change, of less than 10%.
